(19) United States
(12) Patent Application Publication
(10) Pub. No.: US 2005/0070629 A1
(43) Pub. Date: Mar. 31, 2005

(54) Inkjet ink

(76) Inventor: C. Chad Roberts, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/912,273

(22) Filed: Aug. 5, 2004

Related U.S. Application Data
(60) Provisional application No. 60/492,905, filed on Aug. 6, 2003.

(51) Int. Cl. C03C 17/00; C09D 11/00

(52) U.S. Cl. 523/160; 523/161

(57) ABSTRACT

This invention pertains to an inkjet ink, in particular to an aqueous inkjet ink comprising pigment colorant and a specified latex binder based on a chlorinated butadiene monomer. The ink is particularly advantageous for jetting onto textile substrates.

### CROSS-REFERENCE TO RELATED APPLICATION

This application claims priority under 35 U.S.C. §119 from U.S. Provisional Application Ser. No. 60/492,905 (filed Aug. 6, 2003), the disclosure of which is incorporated by reference herein for all purposes as if fully set forth.

### BACKGROUND OF THE INVENTION

This invention pertains to an inkjet ink, in particular to an aqueous inkjet ink comprising pigment colorant and a specified latex binder. The ink is particularly advantageous for jetting onto textile substrates.

The printing of textiles is currently accomplished primarily by rotary screen methods. In operation, screen printing is rapid and, for large runs, cost effective. However, cutting screens is expensive and time consuming thus making the per unit cost for short runs quite substantial and, in many cases, prohibitive.

A digital printing method such as inkjet printing offers a number of potential benefits over conventional screen printing methods. Digital printing eliminates the set up expense associated with screen preparation and can potentially enable cost effective short run production.

Inkjet printing furthermore allows visual effects such as tonal gradients and infinite pattern repeat size that cannot be practically achieved by a screen printing process.

One such digital printing system for textiles is disclosed in commonly owned US2003/0128246A1, which is incorporated by reference herein for all purposes as if fully set forth.

However, inkjet printing as it exists today is disadvantageous because of relatively slow speed. To be competitive with screen printing even for short runs, the speed of inkjet printers needs to increase.

Another disadvantage of inkjet printing, in particular inkjet printing with pigmented ink, is inkjet printed fabrics are particularly susceptible to color removal by abrasion and thus have poor durability or crock fastness.

Even as inkjet hardware improvements are made to increase printing speeds, adoption of inkjet printing in the textile industry will be impeded if methods to also improve crock fastness and wash fastness are not found.

U.S. Pat. No. 4,597,794 discloses inkjet ink formulations suitable for textile. Fabrics were imaged with this ink and set by heating at 150° C. for five minutes. Wash fastness was described as excellent.

U.S. Pat. No. 5,897,694 discloses inkjet ink formulations comprising, as an additive, a transition metal chelate, which provides improved wash fastness.

U.S. Pat. No. 5,958,561 discloses an ink/textile combination wherein the textile is pretreated with a cross-linkable thermoplastic polymer and then imaged with an aqueous ink and cured at temperatures of 100-190° C. Improved wash fastness was obtained.

U.S. Pat. No. 6,146,769 discloses an ink/textile combination wherein an interactive polymer, in the ink or pretreated or on the textile, helps bind the particulate colorant and provide wash fastness.

JP-A-09/143407 (1997) discloses an inkjet ink with thermoset resin which is imaged on fabric and fixed by heating at 130° C. The image is said to be water resistant.

JP-A-08/283636 (1996) discloses an inkjet ink with specified resin emulsions having high Tg. Fabric imaged with this ink is fixed at elevated temperature to provide washfastness.

WO03/029362 discloses a pigmented inkjet ink suitable for textile comprising an emulsion polymer and a cross-linking agent which improve crock and wash fastness.

Commonly owned US2003/0160851 discloses a fusing process to involving the application of heat and pressure to an inkjet-printed textile, which improves crock.

All of the above publications are incorporated by reference herein for all purposes as if fully set forth.

Still, there is need in the art for improved durability of inkjet images on textile, especially in cases where the colorant is pigment.

### SUMMARY OF THE INVENTION

In one aspect, the present invention pertains to an inkjet ink comprising a pigment colorant, an aqueous vehicle and a polymer latex additive, wherein the polymer of the polymer latex additive is derived at least in part from a chlorinated butadiene monomer. Preferably the chlorinated butadiene monomer is selected from 2-chlorobutadiene (chloroprene), 1-chlorobutadiene, 2,3-dichlorobutadiene and mixtures thereof. Preferably the polymer is derived from at least about 10%, more preferably at least about 30%, most preferably at least about 50%, by weight chlorinated butadiene monomer based on total monomer weight.

In accordance with another aspect of the present invention, there is provided an ink set comprising at least three differently colored inks, wherein at least one of the inks is an aqueous inkjet ink as set forth above.

The present invention also provides a method for ink jet printing onto a substrate, comprising the steps of:
(a) providing an ink jet printer that is responsive to digital data signals;
(b) loading the printer with a substrate to be printed;
(c) loading the printer with the above-mentioned inkjet ink or inkjet ink set; and
(d) printing onto the substrate using the inkjet ink or inkjet ink set in response to the digital data signals.

A preferred substrate is a textile substrate, and it is also preferred to treat the printed substrate with heat and/or pressure, and more preferably both heat and pressure (a fusing process).

Use of the inks of the present invention for printing textile substrates can result in a crock of at least 4/dry and 3/wet according to test method AATCC 8-1996.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise.

### DETAILED DESCRIPTION OF THE PREFERRED EMBODIMENTS

Colorant

The colorants of the present invention are pigments and, by definition, substantially insoluble in the ink vehicle. Traditionally, pigments are stabilized to dispersion in a vehicle by dispersing agents, such as polymeric dispersants or surfactants. More recently though, so-called “self-dispersible” or “self-dispersing” pigments (hereafter “SDP”) have been developed. As the name would imply, SDPs are dispersible in water, or aqueous vehicle, without dispersants. See, for example, U.S. Pat. No. 5,554,739, U.S. Pat. No. 5,571,311, U.S. Pat. No. 5,609,671, U.S. Pat. No. 5,672,198, U.S. Pat. No. 5,698,016, U.S. Pat. No. 5,707,432, U.S. Pat. No. 5,718,746, U.S. Pat. No. 5,747,562, U.S. Pat. No. 5,749,950, U.S. Pat. No. 5,803,959, U.S. Pat. No. 5,837,045, U.S. Pat. No. 5,846,307, U.S. Pat. No. 5,851,280, U.S. Pat. No. 5,861,447, U.S. Pat. No. 5,885,335, U.S. Pat. No. 5,895,522, U.S. Pat. No. 5,922,118, U.S. Pat. No. 5,928,419, U.S. Pat. No. 5,976,233, U.S. Pat. No. 6,057,384, U.S. Pat. No. 6,099,632, U.S. Pat. No. 6,123,759, U.S. Pat. No. 6,153,001, U.S. Pat. No. 6,221,141, U.S. Pat. No. 6,221,142, U.S. Pat. No. 6,221,143, U.S. Pat. No. 6,277,183, U.S. Pat. No. 6,281,267, U.S. Pat. No. 6,329,446, U.S. Pat. No. 6,332,919, U.S. Pat. No. 6,375,317, US2001/0035110, EP-A-1086997, EP-A-1114851, EP-A-1158030, EP-A-1167471, EP-A-1122286, WO01/10963, WO01/25340 and WO01/94476, the disclosures of which are incorporated by reference herein for all purposes as if fully set forth.

Preferably, when a dispersant for the pigment is employed, the dispersant is a random or structured polymeric dispersant. Preferred random polymers include acrylic polymers and styrene-acrylic polymers. Most preferred are structured dispersants which include AB, BAB and ABC block copolymers, branched polymers and graft polymers. Some useful structured polymers are disclosed in U.S. Pat. No. 5,085,698, EP-A-0556649 and U.S. Pat. No. 5,231,131, which are incorporated by reference herein for all purposes as if fully set forth.

Useful pigment particle size is typically in the range of from about 0.005 micron to about 15 micron. Preferably, the pigment particle size should range from about 0.005 to about 5 micron, more preferably from about 0.005 to about 1 micron, and most preferably from about 0.005 to about 0.3 micron.

In the case of organic pigments, the ink may contain up to about 30% pigment by weight, but will generally be in the range of about 0.5% to about 15%, preferably about 0.6% to about 8%, by weight of the total ink composition for most ink jet printing applications. Inks with inorganic pigment tend to contain somewhat higher weight percentages of pigment than comparable inks employing organic pigment because of the generally higher specific gravity inorganic pigments. Typically, pigment levels are in the range of about 0.01 to about 10% by weight, more preferably about 2 to about 8 % by weight, based on the total weight of the ink.

When dispersants are used, they are typically present at pigment to dispersant weight ratios ranging from about 2:1 to about 1:2.

A useful pigment set for textile applications includes, for example Carbon black and Color Index colorants pigment blue 15, pigment red 122 and pigment yellow 14. To expand the gamut, the set can include additional inks with other colorants such as pigment orange 34 and pigment green 36.

Pigments are routinely referred to by their Color Index (“CI”) number. Information about pigments with “CI” numbers can be found from the “Colour Index” published by Society of Dyers and Colourists (SDC) in conjunction with the American Association of Textile Chemists and Colorists (AATCC). The SDC web site is http://www.sdc.org.uk/publications/ci4intro.htm, and further information may be found by reference thereto.

Aqueous Vehicle

The term “aqueous vehicle” refers to water or a mixture of water and at least one water-soluble organic solvent (co-solvent). Selection of a suitable mixture depends on requirements of the specific application, such as desired surface tension and viscosity, the selected colorant, drying time of the ink, and the type of substrate onto which the ink will be printed. Representative examples of water-soluble organic solvents that may be selected are disclosed in U.S. Pat. No. 5,085,698 (the disclosure of which is incorporated by reference herein for all purposes as if fully set forth).

If a mixture of water and a water-soluble solvent is used, the aqueous vehicle typically will contain about 30% to about 95% water with the balance (i.e., about 70% to about 5%) being the water-soluble solvent. Preferred compositions contain about 60% to about 95% water, based on the total weight of the aqueous vehicle.

The amount of aqueous vehicle in the ink is typically in the range of about 70% to about 99.8%, and preferably about 80% to about 99.8%, based on total weight of the ink.

The aqueous vehicle can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-Alkanediols are preferably 1,2-C4-6 alkanediols, most preferably 1,2-hexanediol. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont).

The amount of glycol ether(s) and 1,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and preferably about 0.2 to about 2%, based on the total weight of the ink.

Polymer Latex

The term latex as used herein refers to a polymer particle that is dispersed in the vehicle. A latex is sometimes referred to as an “emulsion polymer”. A latex is stabilized to dispersion by stabilizers which can be part of the polymer itself (internal stabilizers) or separate species (external stabilizers) such as emulsifiers.

The latex polymer of the present invention is comprised of chlorinated butadiene monomers. Preferably, the chlorinated butadiene monomers are selected form 2-chlorobutadiene (“chloroprene”), 1-chlorobutadiene, 2,3-dichlorobutadiene and mixtures thereof. The most preferred chlorinated monomer is chloroprene. Preferably the polymer contains, on a weight basis, at least 10% chlorinated butadiene, more preferably at least 30%, most preferably at least 50%.

Polychloroprene liquid dispersion or latex is sold under a number of tradenames including Bayprene (Bayer), Denka-Chloroprene (Denki-Kagaku Kogyo), Butaclor (Distugil), Neoprene (DuPont Dow Elastomers), Skyprene (Tosoh), Shoprene (Showa Denko), and other versions are available from China, Armenia and Russia.

Commercially available latexes have a median particle size in the range of about 0.02 to 3 microns. For the present invention, the median particle size should preferably be less than 1 micron, more preferably more preferably less than 0.5 microns, and most preferably in the range of about 0.03 to 0.3 microns.

Polymer synthesis for these latexes can be performed under emulsion polymerization conditions with standard free radical initiators, chain transfer initiators, and surfactants. Chain transfer agents such as dodecyl mercaptan and sulfur are used to control the molecular weight, branching, and gel content. Molecular weight (Mw) is typically in the range of 100,000 to over 1,000,000 g/mol. The percent conversion is also controlled to limit the gel content.

The reactivity of chlorinated butadienes is several times that of most vinyl or acrylic monomers, making co-polymerization with non-chlorinated monomers difficult. However, the addition of a Lewis acid complexing agent can enable copolymerization of chlorinated butadienes with most monomers such as butadiene, isoprene, dimethylbutadiene, acrylonitrile, styrene, acrylic acid, methacrylic acid, and esters thereof.

The latex polymers used in this invention tend to display crystallinity resulting from the polymer conformation. The conformation of polychloroprene, for instance, is predominately 1,4-trans with increasing regularity inversely proportional with the polymerization temperature. While nearly 100% 1,4-trans polymer may be obtained by polymerization at −150° C., most commercial polychloroprenes are synthesized at 0-40° C. and contain 90% 1,4-trans conformation. This high degree of structural regularity results in stress-induced crystallization and up to 10% crystallinity, which translates to useable strength even in the uncured resin, and high tensile strength in the cured resin. The degree of crystallinity and crystallization rate may also be controlled by incorporation of a small percentage of comonomer. For the present invention, higher levels of crystallinity lead to improved abrasion resistance and better crock and wash fastness.

The polymer latex is generally used, on a polymer solids basis, in the range of about 0.5 to about 30%, and more typically in the range of about 1 to about 20%, by weight based on the total weight of the ink.

Other Ingredients

In addition to the pigment, vehicle and polymer components mentioned described above, other ingredients, as are well known to those of ordinary skill in the art, can be added to optimize performance. Such other ingredients may be formulated into the inkjet ink, to the extent that such other ingredients do not interfere with the stability and jetablity of the ink, which may be readily determined by routine experimentation.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″, N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Drop velocity, separation length of the droplets, drop size and stream stability are greatly affected by the surface tension and the viscosity of the ink. Ink jet inks typically have a surface tension in the range of about 20 dyne/cm to about 70 dyne/cm at 25° C. Viscosity can be as high as 30 cP at 25° C., but is typically somewhat lower. The ink has physical properties are adjusted to the ejecting conditions and printhead design. The inks should have excellent storage stability for long periods so as not clog to a significant extent in an ink jet apparatus. Further, the ink should not corrode parts of the ink jet printing device it comes in contact with, and it should be essentially odorless and non-toxic.

The latex polymer of this invention tends to provide low viscosity even at high solids loading. This property can be particularly advantageous when formulating inks for printheads requiring lower viscosity. Although not restricted to any particular viscosity range or printhead, the viscosity (at 25° C.) of the inventive inks can advantageously be less than about 10 cps, and even less than about 8 cps.

Ink Sets

The ink sets in accordance with the present invention preferably comprise at least three differently colored inks, such as cyan (C), magenta (M) and Yellow (Y), and preferably at least four differently colored inks (such as CMY and black (K)), wherein at least one of the inks is an aqueous inkjet ink comprising:
(a) a pigment colorant;
(b) an aqueous vehicle; and
(c) a latex polymer additive
   as set forth above.

The other inks of the ink set are preferably also aqueous inks, and may contain dyes, pigments or combinations thereof as the colorant. Such other inks are, in a general sense, well known to those of ordinary skill in the art.

Preferably the at least three differently colored inks comprise a C, an M and a Y, wherein each of the said CMY individually comprises components (a), (b) and (c) above. Also preferably, the fourth ink if present comprises a K.

Substrates

The present ink compositions and ink sets are particularly advantageous for printing on textile substrates.

Textiles useful in this invention include, but are not limited to cotton, wool, nylon, polyester and the like, and blends thereof. The finished form of the textile includes, but is not limited to, fabrics, garments, furnishings such as carpets and upholstery fabrics, and the like. Textiles can contain natural and synthetic materials, and blends thereof, and can be treated or untreated as is known in the art.

The textile, once printed, is preferably fused at elevated temperature and pressure, such as disclosed in previously incorporated U.S. Pat. No. 2003/0160851.

Generally, the upper temperature limit is dictated by the tolerance of the particular textile being printed. The lower temperature limit is determined by the amount of heat needed to achieve the desired level of durability. Generally, fusion temperatures will be at least about 80° C. and preferably at least about 100° C., more preferably at least about 140° C. and most preferably at least about 160° C.

Fusion pressures required to achieve improved crock can be very modest. Thus, pressures can be about 3 psi, preferably at least about 5 psi, more preferrable at least about 8 psi and most preferably at least about 10 psi. Fusion pressures of about 30 psi and above seem to provide no additional benefit to crock, but such pressures are not excluded.

The duration of fusion (amount of time the printed textile is under pressure at the desired temperature) was not found to be particularly critical. Most of the time in the fusion operation generally involves bringing the print up to the desired temperature. Once the print is fully up to temperature, the time under pressure can be brief (seconds).

### EXAMPLES

Preparation of Macromonomer for Dispersant 1

The macromonomer ethoxytriethyleneglycol methacrylate-co-methacrylic acid, 15.0/85.0 by weight was prepared using the following procedure:

A mixture of isopropanol (530.5 gm), acetone (77.5 gm), methacrylic acid (70.1 gm) and ethoxytriethyleneglycol methacrylate (12.4 gm) was charged into a 3 liter flask equipped with a thermometer, stirrer, additional funnels, reflux condenser and a means of maintaining a nitrogen blanket over the reactants. The mixture was heated to reflux temperature and refluxed for about 20 minutes. Then a solution of diaquabis(borondifluorodiphenyl glyoximato) cobalt (II), CO(DPG-BF2) (0.1035 gm), 2,2′-azobis(methylbutyronitrile), (VaZoTm 67, by E.I. du Pont de Nemours and Company, Wil-mington, Del.) (0.78 gm) and acetone (21.5 gm) was added. Subsequently, two solutions, the first composed of methacrylic acid (280.1 gm) and ethoxytriethyleneglycol methacrylate (49.4 gm) and the second composed of Co(DPG-BF2) (0.1035 gm), Vazo™ 67 (4.5 gm) and acetone (47.5 gm) were simultaneously added while the reaction mixture was held at reflux temperature at about 72° C. The addition of the first solution was completed in 4 hours and the addition of the second solution was completed in 90 minutes. When the addition of second solution was completed, the addition of a new solution comprised of Co(DPG-BF2), (0.041 gm), Vazo™ 52 (2.30 gm) and acetone (40.5 gm) was begun and was completed in 75 minutes.

A final solution comprising Co(DPG-BF2) (0.062 gm), Vazo™ 52 (2.30 gm) and acetone (40.5 gm) was added over a period of 75 minutes while the reaction mixture was held at reflux temperature throughout the course of addition. Reflux was continued for another hour and the solution was cooled to room temperature.

The resulting macromonomer solution was a clear thin polymer solution and had a solids content of about 34.8%. The macromonomer contained 15% of ethoxytriethyleneglycol methacrylate and 85% of methacrylic acid (by weight) and had a weight average molecular weight of 3,330 and a number average molecular weight of 1,980 as measured by Gel Permeation Chromatography (GPC) on a methylated macromonomer sample using polymethyl methacrylate as the standard.

Preparation of Dispersant 1

This demonstrates the preparation of a graft copolymer, phenoxyethyl acrylate-g-ethoxy-triethyleneglycol methacrylate-co-methacrylic acid, 61.6/5.8/32.6 % by weight, from the macromonomer herein before described.

A mixture of macromonomer (114.9 gm) and 2-pyrrolidone (20.0 gm) was charged into a 5OOmL flask equipped with a thermometer, stirrer, additional funnels, reflux condenser and a means of maintaining a nitrogen blanket over the reaction mixture. The mixture was heated to reflux temperature and refluxed for about 10 minutes. A solution containing t-butyl peroxypivalate (Lupersol™ 11, Elf Atochem, Philadelphia, Pa.) (0.67 gm) and acetone (10.0 gm) was added. Subsequently, two solutions, the first comprised of phenoxyethyl acrylate (64.2 gm) and 2-pyrrolidone (20.0 gm), and the second comprised of Lupersol™ 11 (2.67 gm) and acetone (20.0 gm), were simultaneously added, over 3 hours, to the reactor while the reaction mixture was held at reflux temperature, at about 70-71° C. Following this addition the reaction mixture was refluxed an additional hour. The final solution being comprised of Lupersol™ 11 (0.67 gm) and acetone (20.0 gm) was then added in a single shot. The reaction mixture was refluxed at about 65° C. for an additional 2 hours. The mixture was distilled until about 99.8 g of the volatiles were collected. Then, 105.0 g of 2-pyrrolidone was added to yield 238.0 g of a 43.3% polymer solution.

The graft copolymer had a weight average molecular weight of 18,800 and a number average molecular weight of 8,810 as measured by Gel Permeation Chromatography (GPC) on a methylated sample using polymethyl methacrylate as the standard.

Preparation of Black Concentrate

Black dispersion concentrate was prepared according to the following procedure: Mix well the following ingredients: (i) 57.83 parts by weight (pbw) deioinized water, (ii) 21.67 pbw of Dispersant 1, and (iii) 2.5 pbw of dimethylethanolamine. Gradually add carbon black pigment (18 pbw). The batch was circulated in the mill for grinding. The ground dispersion was then diluted to 15 wt % pigment for final application in making inks. The 15 wt % dispersion had the following properties: Brookfield viscosity of 12 cps, pH of 7.8, median particle size of 77 nm.

Polymer Latex (Binder)

Neoprene latex 115 (DuPont Dow Elastomers) is an emulsion copolymer of chloroprene and about 2.8% methacrylic acid that has a median particle size of 0.3 microns, a low degree of crystallinity (about 2%) and low gel fraction (20%).

Neoprene latex 750 (DuPont Dow Elastomers) is an emulsion copolymer of chloroprene and 2,3-dichloro-1,3-butadiene that has an average particle size of 0.12 microns, a low degree of crystallinity (about 2%) and moderate gel fraction (60%).

Neoprene latex 671A (DuPont Dow Elastomers) is an emulsion homopolymer of chloroprene that has an average particle size of 0.21 microns, a moderate degree of crystallinity (about 5%) and moderate gel fraction (40%).

The ‘acrylic latex’ (comparative binder) was the same as the “dispersed binder” described for pigmented textile inks in the examples of previously incorporated U.S. Pat. No. 2003/0128246A1.

Ink Preparation

Inks were prepared by mixing ingredients according to the following recipes. The final pH was adjusted to 7.5 to 8.5 with dimethylethanol amine.

| Ink 1 - Ingredients | Amount (g) |
|---|---|
| Black concentrate (15% pigment) | 35.6 |
| Neoprene 750 liquid dispersion (49% solids) | 21.1 |
| Gycerol | 6.88 |
| Dipropylene glycol monomethylether | 6.25 |
| Liponics ® EG-1 | 9.38 |
| Dynol ® 604 | 0.50 |
| Proxel ® GXL | 0.25 |
| Water | 45.4 |
| Viscosity (cPs) | 6.0 |
| Surface tension (dynes/cm) | 29.4 |

| Ink 2 - Ingredients | Amount (g) |
|---|---|
| Black concentrate (15% pigment) | 35.44 |
| Neoprene 671A liquid dispersion | 17.44 |
| (49% solids) | |
| Gycerol | 6.88 |
| Dipropylene glycol monomethylether | 6.25 |
| Liponics ® EG-1 | 9.38 |
| Dynol ® 604 | 0.5 |
| Proxel ® GXL | 0.25 |
| Water | 48.92 |
| Viscosity (cPs) | 5.8 |
| Surface tension (dynes/cm) | 28.5 |

| Ink 3 - Ingredients (Comparative) | Amount (g) |
|---|---|
| Black concentrate (15% pigment) | 35.5 |
| Acrylic Latex (35%) | 30.22 |
| Gycerol | 6.88 |
| Dipropylene glycol monomethylether | 6.25 |
| Liponics ® EG-1 | 9.38 |
| Dynol ® 604 | 0.50 |
| Proxel ® GXL | 0.25 |
| Water | 36.42 |
| Viscosity (cPs) | 7.3 |
| Surface tension (dynes/cm) | 29.5 |

| Ink 4 - Ingredients | Amount (g) |
|---|---|
| Black concentrate (15% pigment) | 280.53 |
| Neoprene 115 liquid dispersion (49% solids) | 213.54 |
| Gycerol | 80 |
| Dipropylene glycol monomethylether | 30 |
| Ethylene glycol | 110.22 |
| Surfynol ® 104E | 4 |
| Silwet ® L-77 | 2 |
| Proxel GXL | 2 |
| Water | 277.71 |
| Viscosity (cPs) | 8.1 |
| Surface tension (dynes/cm) | 28.4 |

Commercially available materials used in the preceding examples are: Dynol® 604 and Surfynol® 104E surfactants from Air Produts; Silwet® L-77 surfactant from Witco; Liponics® EG-1 ethoxylated glycerol from Lipo Corporation; and Proxel® GXL biocide from Avecia.

Crock Fastness

Colorfastness to rubbing (crock fastness) was determined according to AATCC method 8-1996 using an AATCC crockmeter model CM-5 (Atlas Electric Devices Company, Chicago, Ill.). White test cloth swatches were obtained from Testfabrics, Inc. (West-Pittston, Pa.), and this catalog item number was listed as CROCK 2, 2×2″ crock square from desized, bleached combed cotton lawn with a 80×84 thread count. The arm of the crockmeter was set to outermost hole giving the longest stroke length so that the crock motion take place along a 10.4 cm track. On each stroke, for a total of 10 strokes, the crock finger moved 10.4 cm back and forth 10.4 cm. All samples were hung or placed separately at 70° F./65% RH to allow for conditioning of the print for a minimum of four hours prior to crock testing. Crock fastness was determined with the test fabric dry (dry crock) and with the test fabric moistened with de-ionized water (wet crock).

Crock is rated on a scale of 0 to 5 where 5 is most desirable and represents no color rub off. The numerical crock ratings were determined spectroscopically using a Minolta 3600D (desktop or handheld unit) and the Spectramatch PC program. Reported crock data correspond to the AO4 values from the Minolta/Spectramatch package calculated according to the color index ISO 105.AO4 method. Minimum crock ratings of 3/dry and 2/wet are generally required for commercial applications. Higher crock rating of 4/dry and 3/wet are more preferred in order to match values obtainable from traditional screen printing processes.

Wash Fastness

Colorfastness to laundering (Wash fastness) was determined according to the accelerated AATCC Method 61-1996 3A and 2A test methods. The 2A method simulates five commercial or home machine laundering at warm setting (38° C./100° F.) whereas the 3A method is comparable to five commercial (49 C/120° F.) or home launderings at hot setting (60° C./140° F.).

The washfastness rating is based on the fade of the sample after washing. A rating of 5 indicates no fade, and a rating of 1 indicates the sample has been essentially washed white. Reported wash fastness ratings correspond to the AO3 values from the Minolta/Spectramatch package which are calculated according to the color index ISO 105.AO4 method. Although commercial requirements vary by application, inks should provide a rating of at least 3 for both 2A and 3A washfastness tests, more preferably at least 4 for 2A washfastness, and most preferably a rating of at least 4 for both 2A and 3A washfastness.

### Example 1

Solids blocks (100% coverage) of ink 4 were printed on 419 cotton using a Dupont 2020 Textile Printer. As a comparison, solids blocks of the commercially available DuPont Artistri® pigment black textile ink were printed on the DuPont Ink Jet 3210 printer. The imaged areas were post-treated by fusion at 160° C. and 10 psi pressure for 1 minute. The crock and wash fastness test results on the post-treated samples are tabulated below. The data demonstrate significant improvement in wet crock and wash fastness for the inventive ink compared to the Artistri® commercial ink.

| | | Wet | 2A Wash | 3A Wash |
|---|---|---|---|---|
| Ink | Dry Crock | Crock | fastness | fastness |
| Ink 4 | 5 | 3.5 | 4.5 | 4.0 |
| Artistri ® Pigment Black | 4.5 | 2.5 | 3.5 | 2.5 |

### Example 2

Solid blocks of inks 1, 2 and 3 were coated on 439 cotton using a #7 rod on a fast drawdown tool (from Gardner). The samples were post-treated by fusion at 160° C and 10 psi pressure for 1 minute. The results from crock and wash fastness testing of the samples are tabulated below. The data demonstrates significantly higher dry crock for inventive Inks 1 and 2 compared to Ink 3.

| Ink | Dry Crock | Wet Crock |
|---|---|---|
| Ink 1 | 4.5 | 2.5 |
| Ink 2 | 4.5 | 2.0 |
| Ink 3 (comparative) | 3.0 | 2.0 |

1. An inkjet ink comprising a pigment colorant, an aqueous vehicle and a polymer latex additive, wherein the polymer of the polymer latex additive is derived at least in part from a chlorinated butadiene monomer.

2. The ink of claim 1, wherein the chlorinated butadiene monomer is selected from the group consisting of 2-chlorobutadiene, 1-chlorobutadiene, 2,3-dichlorobutadiene and mixtures thereof.

3. The ink of claim 1, wherein the polymer of the polymer latex is derived from at least about 10% by weight chlorinated butadiene monomer based on total monomer weight.

4. The ink of claim 3, wherein the polymer of the polymer latex is derived from at least about 30% by weight chlorinated butadiene monomer based on total monomer weight.

5. The ink of claim 4, wherein the polymer of the polymer latex is derived from at least about 50% by weight chlorinated butadiene monomer based on total monomer weight.

6. The ink of claim 1, wherein the polymer latex additive is present in an amount of from about 0.5 to about 30 wt% (polymer solids) based on the total weight of the ink.

7. The ink of claim 1, having from about 0.1 to about 10 wt% pigment based on the total weight of the ink, a surface tension in the range of about 20 dyne/cm to about 70 dyne/cm at 25° C., and a viscosity of lower than about 30 cP at 25° C.

8. An ink set comprising at least three differently colored inks, wherein at least one of the inks is an inkjet ink comprising a pigment colorant, an aqueous vehicle and a polymer latex additive, wherein the polymer of the polymer latex additive is derived at least in part from a chlorinated butadiene monomer.

9. The ink set of claim 8, wherein the at least three differently colored inks comprise a cyan (C), a magenta (M) and a yellow (Y) ink, wherein each of the CMY inks individually comprises a pigment colorant, an aqueous vehicle and a polymer latex additive, wherein the polymer of the polymer latex additive is derived at least in part from a chlorinated butadiene monomer.

10. The ink set of claim 8, wherein the chlorinated butadiene monomer in the polymer of the polymer latex additive is selected from the group consisting of 2-chlorobutadiene, 1-chlorobutadiene, 2,3-dichlorobutadiene and mixtures thereof.

11. A method for ink jet printing onto a substrate, comprising the steps of:
(a) providing an ink jet printer that is responsive to digital data signals;
(b) loading the printer with a substrate to be printed;
(c) loading the printer with the inkjet ink inkjet ink comprising a pigment colorant, an aqueous vehicle and a polymer latex additive, wherein the polymer of the polymer latex additive is derived at least in part from a chlorinated butadiene monomer; and
(d) printing onto the substrate using the inkjet ink in response to the digital data signals.

12. The method of claim 11, further comprising the step of (e) post-treating the printed substrate with heat and/or pressure.

13. The method of claim 11, wherein the substrate is a textile.

14. The method of claim 13, wherein the crock of the printed textile substrate is at least 4/dry and 3/wet according to test method AATCC 8-1996.

15. The method of claim 11, wherein the printer is loaded with an ink set comprising at least three differently colored inks, wherein at least one of the inks is an inkjet ink comprising a pigment colorant, an aqueous vehicle and a polymer latex additive, wherein the polymer of the polymer latex additive is derived at least in part from a chlorinated butadiene monomer; and the substrate is printed onto using the ink set in response to the digital data signals.
